(19) United States
(12) Patent Application Publication
(10) Pub. No.: US 2018/0238371 A1
(43) Pub. Date: Aug. 23, 2018

(54) SELF-PIERCING RIVET WITH HIGH MECHANICAL STRENGTH AGAINST TEARING OUT AND SHEARING

(71) Applicant: A. RAYMOND ET CIE, Grenoble (FR)

(72) Inventors: Mathieu COCHARD, Proveysieux (FR); Jonathan FENOLL, Seyssinet (FR); Yves-Marie DEPAIL, Grenoble (FR)

(21) Appl. No.: 15/772,032

(22) PCT Filed: Oct. 18, 2016
(86) PCT No.: PCT/FR2016/052692

§ 371 Date: Apr. 27, 2018

(30) Foreign Application Priority Data
Oct. 27, 2015 (FR) 1560262

(51) Int. Cl. F16B 19/08; F16B 19/10

(52) U.S. Cl. CPC F16B 19/083; F16B 19/1054; F16B 19/086

(57) ABSTRACT

A self-piercing rivet comprising a bearing flange and a piercing end with an expandable hollow tubular body extending axially between the flange and the piercing end, the body comprising a cylindrical first portion that is adjacent to the flange, a cylindrical second portion that is adjacent to the piercing end, and a radially-expandable third portion between said cylindrical first and second portions, the rivet further comprises a breakable rod that extends axially inside the hollow body to drive the body in axial rotation and to deform it radially at said expandable third portion under the effect of axial traction. The third portion (7) of the body is designed to produce, before being deformed radially, an abrasion or deburring effect on the peripheral edge of a hole being pierced by the piercing end.

This application is a 371 national phase entry of PCT/FR2016/052692, filed 18 Oct. 2016, which claims benefit of French Patent Application No. 1560262, filed 27 Oct. 2015, the entire contents of which are incorporated herein by reference for all purposes.

### TECHNICAL FIELD

The invention relates to a self-piercing rivet comprising a bearing flange and a piercing end, with a radially-expandable hollow tubular body extending axially between the flange and the piercing end, the tubular body comprising a cylindrical first portion that is adjacent to the flange, a cylindrical second portion that is adjacent to the piercing end, and an expandable barrel-shaped third portion between the cylindrical first and second portions, the rivet further comprising a rod that extends axially inside the hollow body.

### RELATED ART

It is known to use a self-drilling expansion anchor to assemble two elements in simple manner, such as assembling a part to a support.

Documents FR 2 927 382 and FR 2 992 698 describe self-drilling anchors with a head in the form of a flange, a piercing end, and an anchor body between the flange and the piercing end. The anchor body comprises a threaded portion suitable for co-operating with the thread of a screw. However, in the automotive industry those types of self-drilling anchor do not satisfy manufacturers since they have low shearing and tearing strengths, especially in the event of an impact.

Patent document FR 2 868 818 describes a self-drilling anchor with an anchor body that includes an inner sheath for receiving a tool for driving the anchor body in rotation and then for applying traction to the anchor body in axial translation in order to cause the anchor body to deform radially. However, after the tool has been removed, a through orifice made by the tool is left unfilled, which does not enable the structure of the self-drilling anchor to be reinforced in optimal manner in order to improve strength.

Documents U.S. Pat. No. 4,293,258 and U.S. Pat. No. 3,935,786 describe a self-drilling rivet with a hollow body in which there extends axially a rod for driving the rivet in rotation. However, after piercing, those rivets still present weaknesses in terms of mechanical strength.

Documents WO 8 805 991, U.S. Pat. No. 3,403,593, and KR 2015 0 065 099 describe self-piercing rivets with breakable rods arranged in the body of the rivet.

However, when those rivets are used to pierce composite elements, the anchors or rivets do not make it possible to make “clean” holes since, during piercing, they often lead to delamination and to fibers being torn, as well as to uncontrolled discharge of dust.

Finally, manufacturers seek to increase the speed with which two plates are assembled together, and more particularly when fastening is performed with access to only one side of the plates to be assembled together.

### SUMMARY

The object of the invention is to provide another type of rivet presenting better tearing and shearing strength while being compatible with the constraints of the automotive industry.

More particularly, the invention provides a self-piercing rivet comprising a bearing flange and a piercing end, with a radially-expandable hollow tubular body extending axially between the flange and the piercing end, the tubular body comprising a cylindrical first portion that is adjacent to the flange, a cylindrical second portion that is adjacent to the piercing end, and an expandable barrel-shaped third portion between the cylindrical first and second portions, the rivet further comprises a rod that extends axially inside the hollow body, the rod cooperating with the hollow body to drive it in axial rotation and to deform it radially at the expandable third portion under the effect of axial traction, the rod including a breakable zone disposed flush with the flange when the third portion of the body is completely expanded radially, the rivet being characterized in that the expandable third portion of the tubular body includes slots and strips that are interposed between the slots, and an annular zone of weakness in a transverse mid plane, and in that the third portion is designed to produce, before being deformed radially, an abrasion or deburring effect on the peripheral edge of a hole being pierced by the piercing end.

The self-piercing rivet of the invention may further present the following characteristics:
the strips may have an abrasive outside surface designed to produce an abrasion or deburring effect;
the strips may have a sharp beveled lateral edge for producing the abrasion or deburring effect;
the rod may comprise at one end a first portion that extends inside the first portion of the hollow body and that projects beyond the flange towards the outside of the body;
the rod comprises at the other end a second portion arranged to be received in part in the second portion of the body so as to be blocked axially in the body;
the rod may comprise a third rod portion between the first and second rod portions with the breakable zone, and the third rod portion is arranged so that a segment of the third rod portion is inserted into the first portion of the body when the third portion of the body is completely expanded radially;
the first portion of the tubular body may have an inside surface provided with claws for preventing the rod from moving in axial translation;
the rod may be fastened to the second portion of the tubular body by a tongue and groove system;
the rod may be fastened to the second portion of the tubular body by welding;
the piercing end may be in the form of a hole saw;
the rivet may be made from rolled and welded sheet metal;
the rivet may be made from pressed sheet metal.

With the self-piercing rivet of the invention, two plates can be assembled together, or a part can be assembled to a support quickly and easily. The plates may also be floor mats of an automobile.

With this arrangement of the invention, a fastening can be obtained that presents high tearing and shearing strengths of more than 750 decanewtons (daN).

After the elements to be assembled have been pierced by turning the rivet by means of a screw driver tool cooperating with the rod that has been inserted into the hollow body and that projects relative to the rivet body, the flange comes to bear against the top element to be assembled. Axial traction on the tool thus leads to the rivet body expanding radially in order to anchor the rivet to the plates. When the body is completely expanded radially, the third rod portion is blocked in part inside the first portion of the body that is adjacent to the flange, thus forming a reinforcement that fills the rivet body entirely at the first part of the body in order to strengthen the structure of the expanded rivet. In addition, after the plates have been assembled together, the axial traction exerted on the rod leads to the rod breaking for an appropriate value of traction on the breakable zone in such a manner that the broken rod does not extend past the flange.

Assembly of the two plates, which comprises the steps of piercing and anchoring the rivet on either side of the two plates, may be quick and simplified since it may be performed in a single operation by means of a suitable tightening/traction tool.

The expanded rivet body with a rod portion remaining inside the body makes it possible to ensure sealing from one side to the other of the assembled plates.

In addition, the arrangement of the piercing end and of the hollow tubular body with its third portion that is designed for producing an abrasion or deburring effect on the peripheral edge of the pierced hole, makes it possible to make “clean” holes, but also to contain in the piercing end the discharge of dust and debris caused by piercing.

### BRIEF PRESENTATION OF THE DRAWINGS

The present invention will be better understood and other advantages appear on reading the following description and the accompanying drawings, in which:

FIG. 1 is a perspective view of the self-piercing rivet of the invention;

FIG. 2 is a plan view of the self-piercing rivet of the invention;

FIG. 3 is a plan view of the self-piercing rivet of the invention;

FIG. 4 is an axial section view of the self-piercing rivet of the invention shown in FIG. 3; and

FIG. 5 is an axial section view of the self-piercing rivet of the invention expanded radially.

### DETAILED DESCRIPTION OF EXAMPLE EMBODIMENTS

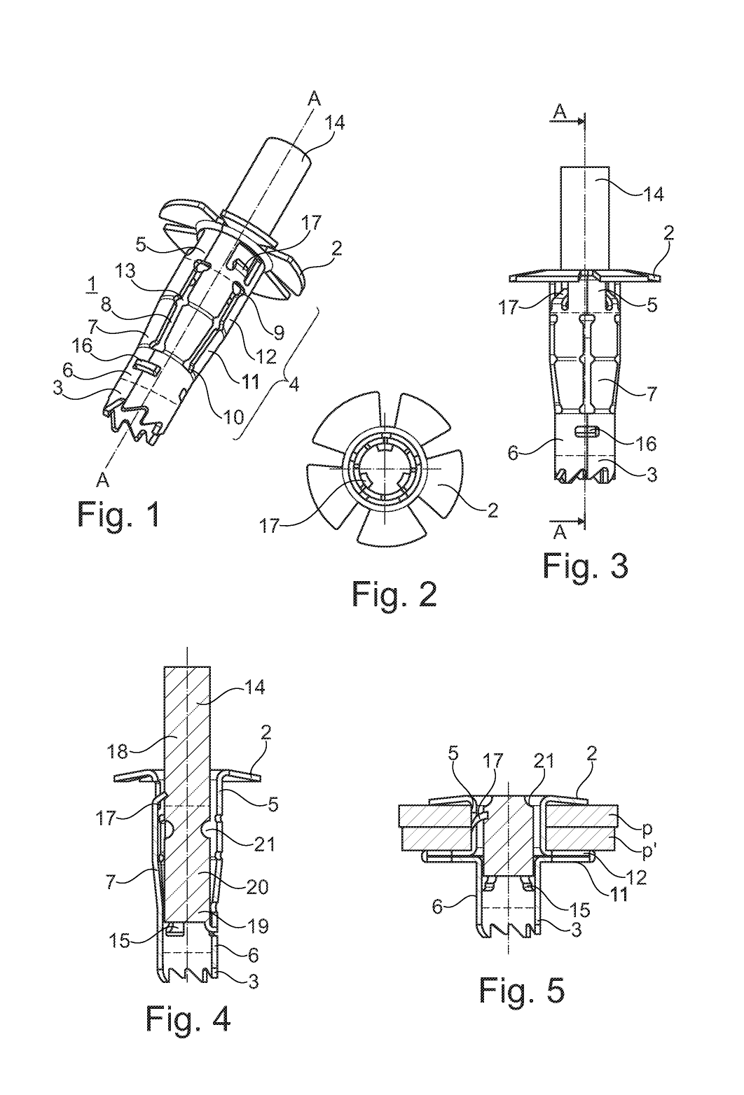

FIGS. 1 to 5 show a rivet 1 of the invention for assembling two plaques (P and P′ shown in FIG. 5). By way of non-limiting example, the plates may be fiberglass plates.

The rivet 1 includes a flange 2, coming to bear for example on one of the plates to be assembled, and a piercing end 3.

The flange 2 extends in a plane that is perpendicular to an axis AA of the rivet 1. The flange 2 may have tabs (not shown) that bite into the bearing surface in order to prevent it from moving in axial rotation.

In this embodiment, the piercing end 3 is of the double-toothed circular hole saw type. The hole saw includes an inside bore with teeth distributed circumferentially about the bore in order to reduce dust and fiber-tearing during piercing.

Without going beyond the ambit of the invention, the piercing end could be of the drill-bit type with a diamond coating (not shown).

Between the flange 2 and the piercing end 3, the rivet 1 presents a barrel-shaped tubular body 4.

The body 4 includes a bore that can be subdivided into three portions extending along the axis AA: a cylindrical first portion 5 adjacent to the flange 2; a cylindrical second portion 6 adjacent to the piercing end 3; and an intermediate third portion 7 between the two cylindrical portions 5, 6, which in this embodiment is in the shape of a radially-expandable barrel.

The intermediate third portion 7 includes longitudinal anchoring slots 8 extending parallel to the axis AA between two eyelets 9, 10 made at respective ends of the expandable intermediate third portion 7.

Between them, the slots 8 define bottom and top strips 11, 12, and during radial expansion of the body 4 the strips fold back onto one another, outside the body 4 so as to cause the intermediate third portion 7 to expand.

In order to further facilitate this radial expansion, intermediate other eyelets 13 are made in the middle zone of the expandable intermediate third portion 7, forming an annular zone of weakness in a transverse mid plane.

In this embodiment, the bottom strips 11 have an abrasive outside surface. The top strips 12 may also have an abrasive outside surface.

In this embodiment, the inside surface of the cylindrical first portion 5 of the body 4 adjacent to the flange 2 presents claws 17 that slope towards the inside of the bore of the body 4.

FIG. 2 is a plan view of the rivet 1. The flange 2 presents cut out areas about an inlet orifice of the bore of the body 4.

In the invention, a rod 14, in this embodiment generally cylindrical, the structure of which can be seen in FIG. 4, is inserted into the bore of the rivet body 4. The rod comprises three portions extending along the axis AA: a first portion 18 at one end of the rod 14 designed to be inserted into the first portion 5 of the body 4 and of length that is adapted so that it also projects beyond the flange 2 towards the outside of the rivet body 4; a second portion 19 at the other end of the rod 14 designed to be received in part in the second portion 6 of the rivet body 2; and a third portion 20, between the first and second rod portions 18, 19, which are received in the third portion 7 of the rivet body 4.

The portion projecting from the first rod portion 18 relative to the rivet body 4 serves not only to turn the rivet 1 in the conventional screw driving direction, by means of a tool acting on the portion that extends inside the body 4, but also to apply axial traction.

The second rod portion 19 serves to secure the rod 14 in axial rotation to the second portion 6 of the rivet body 4, in this embodiment, shown by a fastener system of the tongue 15 and groove 16 type. Fastening may also be performed by welding or crimping the rod 14 to the body 4.

In this embodiment, the third rod portion 20 presents a radial constriction zone corresponding to a breakable zone 21.

Thus, in the invention, the rod 14 fills the bore of the rivet body 4 entirely from the second portion 6 of the body 4 in the direction of the flange 2. The rod 14 thus makes it possible to ensure sealing from one side to the other of the elements to be assembled.

The rivet 1 is put into place, in this embodiment in the two plates P, P′ in order to assemble them together, by driving the rivet 1 in rotation in the conventional screw-fastening direction, by means of a screw driver and/or traction tool acting on the first rod portion 18 projecting from the body 4, in order to make a hole in both of the plates P and P′ of FIG. 5.

When the flange 2 bears against the top plate P to be assembled, the tool applies traction in axial translation on the rod 14 in such a manner that the second portion 6 of the body 4 moves towards the flange 2, which causes the expandable third portion 7 of the rivet body 4 to deform radially, the bottom and top strips 11 and 12 moving apart from each other obliquely to the axis AA of the rivet 1 by opening up the anchoring slots 8 until the strips 11 and 12 form a projection underneath the assembled-together plates P, P′.

Once the third portion 7 has expanded completely, as shown in FIG. 5, a segment of the third rod portion 20 is then inserted into the first portion 5 of the body 4 where it is blocked axially by the claws 17 arranged on the inside face of the first portion 5 of the body 4. The sloping claws 17 dig into the material of the rod 14 in the event of the rod 14 being removed from the first portion 5 of the body 4.

The breakable zone 21 on the third rod portion 20 is arranged so that after the elements have been assembled together, the rod 14 being broken by exerting traction on the rod 14 does not allow the segment of the third rod portion 20 that remains inside the rivet body 4 to extend past the rivet body 4, such that the broken rod 14 is flush with the flange 2.

In the invention, the intermediate third portion 7 formed by the slots 8 and the strips 11, 12, is designed, before being deformed radially, to produce an abrasion or deburring effect on the peripheral edge of the hole, when this third portion 7 passes through the hole after the piercing end 3 of the rivet 1 of the invention has passed therethrough.

This abrasion or deburring function may be performed by the outside surfaces of the strips 11, 12, which can be made to be rough. This function may also be performed by the lateral edge(s) of the strips 11, 12, which are beveled so as to be sharp.

Thus, the strips 11, 12 make it possible to sand the inside of the hole in order to eliminate protruding fibers and/or local areas of delamination, so as to obtain a clean and tidy surface all around the hole.

In the invention, the rivet 1 with the rod 14 may be made from rolled and welded sheet metal, or from pressed sheet metal.

The rivet 1 can also be made entirely by molding or injection-molding a plastics material in order to be manufactured at low cost and be used for assembling two automobile floor mats together, or for assembling a floor mat to a plate, for example.

In non-limiting manner, the rivet 1 could also be used for fastening cable tunnels, for positioning heavy or lightweight fastener systems, or for internal fastening in cars with metal or composite bodies.

It could also be made by material addition in a 3D printer if, for example, only a short run is involved.

1. A self-piercing rivet comprising a bearing flange and a piercing end with a radially-expandable hollow tubular body extending axially between said flange and said piercing end, said tubular body comprising a cylindrical first portion that is adjacent to said flange, a cylindrical second portion that is adjacent to said piercing end, and an expandable barrel-shaped third portion between said cylindrical first and second portions, said rivet further comprising a rod that extends axially inside said hollow body, said rod cooperating with said hollow body to drive it in axial rotation and to deform it radially at said expandable third portion under the effect of axial traction, said rod including a breakable zone disposed flush with said flange when said third portion of said body is completely expanded radially, wherein said expandable third portion of said tubular body includes slots and strips that are interposed between said slots, and an annular zone of weakness in a transverse mid plane, and said third portion is designed to produce, before being deformed radially, an abrasion or deburring effect on the peripheral edge of a hole being pierced by said piercing end.

2. A self-piercing rivet according to claim 1, wherein said strips have an abrasive outside surface designed to produce an abrasion or deburring effect.

3. A self-piercing rivet according to claim 1, wherein said strips have a sharp beveled lateral edge for producing the abrasion or deburring effect.

4. A self-piercing rivet according to claim 1, wherein said rod comprises at one end a first portion that extends inside said first portion of the hollow body and that projects beyond said flange towards the outside of said body.

5. A self-piercing rivet according to claim 4, wherein said rod comprises at the other end a second portion arranged to be received in part in said second portion of said body so as to be blocked axially in said body.

6. A self-piercing rivet according to claim 5, wherein said rod comprises a third rod portion between said first and second rod portions with said breakable zone, and said third rod portion is arranged so that a segment of said third rod portion is inserted into said first portion of said body when said third portion of said body is completely expanded radially.

7. A self-piercing rivet according to claim 1, wherein said first portion of said tubular body has an inside surface provided with claws for preventing said rod from moving in axial translation.

8. A self-piercing rivet according to claim 1, wherein said rod is fastened to said second portion of said tubular body by a tongue and groove system.

9. A self-piercing rivet according to claim 1, wherein said rod is fastened to said second portion of said tubular body by welding.

10. A self-piercing rivet according to claim 1, wherein said piercing end of said body is in the form of a hole saw.

11. A self-piercing rivet according to claim 1, wherein said self-piercing rivet is made from rolled and welded sheet metal.

12. A self-piercing rivet according to claim 1, wherein said self-piercing rivet is made from pressed sheet metal.
